(19) United States
(12) Patent Application Publication
(10) Pub. No.: US 2026/0299094 A1
(43) Pub. Date: Oct. 1, 2026

(54) LIDAR SYSTEM FOR MEASURING THE VELOCITY OF FLUIDS

(71) Applicant: OFFICE NATIONAL D'ETUDES ET DE RECHERCHES AÉROSPATIALES, PALAISEAU (FR)

(72) Inventors: David Tomline MICHEL, PALAISEAU (FR); Laurent LOMBARD, PALAISEAU (FR); Matthieu VALLA, PALAISEAU (FR)

(73) Assignee: OFFICE NATIONAL D'ETUDES ET DE RECHERCHES AÉROSPATIALES, PALAISEAU (FR)

(21) Appl. No.: 18/997,547

(22) PCT Filed: Jul. 24, 2023
(86) PCT No.: PCT/FR2023/051153

§ 371 Date: Nov. 5, 2025

(30) Foreign Application Priority Data
Sep. 2, 2022 (FR) FR2208828

(51) Int. Cl. G01S 7/484; G01P 5/26; G01S 7/487; G01S 17/58

(52) U.S. Cl. CPC G01S 7/484; G01P 5/26; G01S 7/4876; G01S 17/58

(57) ABSTRACT

A pulsed LIDAR system that is capable of varying a radiation modulation frequency inside each pulse, such that a component of a detection signal which is of use for measuring a velocity of a target is spectrally shifted according to its distance from the target. Such a LIDAR system makes it possible to spectrally separate the useful component of the detection signal from a narcissus signal which is caused by an output optic being shared by a emission channel and a detection channel of the LIDAR system. The LIDAR can used to measure indicated airspeeds.

### TECHNICAL FIELD

The present description concerns a LIDAR system for carrying out velocimetric measurements, as well as a corresponding measurement method.

### BACKGROUND

LIDAR systems, which stand for “Light Detection And Ranging”, are useful for measuring the distance to and speed of a target. They use a laser beam that is directed at the target and analyze a part of this beam that is retroreflected or backscattered by the target. The distance measurement results from a direct or indirect estimate of the travel time of the radiation over the distance to the target from the LIDAR system and back, and the speed of the target is deduced from a measurement of the Doppler frequency shift affecting the part of the radiation that has been retroreflected or backscattered by the target.

In certain circumstances and for certain applications, it is particularly advantageous for the radiation beam emitted towards the target to consist of a series of successive pulses. In fact, each pulse can thus have instantaneous power values that are much higher than those of continuous radiation, making it possible to increase accordingly the power of the part of the radiation that is collected after being backscattered by the target. This first advantage is particularly important for a LIDAR system designed to measure airspeeds, as the power of the part of the radiation that is collected is very low. A second advantage of using a pulsed LIDAR system is that a continuous laser source incorporated in such a system can then be of a power that does not present an eye hazard to operators.

Such pulsed LIDAR systems can be used to measure the range and velocity of a solid object that forms the target.

But some pulse LIDAR systems are specially dedicated to airspeed measurements. The target then consists of particles which are located in a portion of atmosphere, the pulses are emitted by a emission channel of the LIDAR system towards this portion of atmosphere, and a detection channel of this LIDAR system is adapted to collect the part of the pulses which has been backscattered by the particles located in the portion of atmosphere. A particularity of these LIDAR systems dedicated to airspeed measurements is that they are adapted to detect backscattered parts of emitted pulses with very low power values. According to a possible design of LIDAR systems for airspeed measurements, as described in WO 2021/053290 A1, the portion of atmosphere concerned by a measurement is determined by a convergence of the radiation beam of the emitted pulses. This portion of atmosphere is superimposed on the zone of space, known as the Rayleigh zone, in which the radiation emitted by the LIDAR system is most concentrated.

But for the easiest LIDAR systems to implement, where the same output optic is used for both the emission and detection channels, this output optic generates a partial reflection of the emitted radiation on some of its optical components. This internal reflection produces one or more components in the detection signal that are not related to the target. These components, which come from the optical interface between the LIDAR system and the free propagation space of the radiation, and which are commonly referred to as the narcissus signal, can have a high or even very high intensity. Such a narcissus signal can then be superimposed on a useful component of the detection signal generated by a target located at a short distance from the LIDAR system, preventing such a useful component from being validly detected. In particular, the narcissus signal is much more intense than the useful component of the detection signal in the case of anemometric applications.

From this situation, one aim of the present invention is to provide a LIDAR system for which a useful component of the detection signal relating to a target located at close range can be distinguished from the narcissus signal, and can be used to provide an estimate of the distance and/or speed of this target.

An ancillary aim of the invention is to provide such a LIDAR system which is effective over a short measurement distance, and which enables airspeed measurements to be made.

### SUMMARY

To achieve at least one of these or other purposes, a first aspect of the invention proposes a LIDAR system which is suitable for measuring a velocity of at least one target, and which comprises:
a emission channel, adapted to emit pulses of radiation towards the target through an output optic of the LIDAR system;
a detection channel, comprising a photodetector, and adapted to collect, also through the output optic, and direct onto the photodetector, a portion of the pulses that has been retroreflected or backscattered by the target, so as to produce a detection signal; and
a signal processing unit, configured to output a result of the speed measurement which is relative to the target, from the detection signal.

Such a LIDAR system of the invention also has the following features:
the emission channel is further adapted to vary a modulation frequency of the radiation within each pulse, so that a component of the detection signal that is useful for measuring velocity, referred to as the useful component, is spectrally shifted as a function of a distance of the target from the LIDAR system; and
the signal processing unit is further configured to extract the useful component from a spectrum of the detection signal, so as to isolate this useful component from at least one other component of the detection signal which results from a retroreflection or partial backscattering of the emitted pulses occurring in the output optic of the LIDAR system, and to obtain the result of the velocity measurement from the extracted useful component.

In the LIDAR system of the invention, the useful component of the detection signal is distinguished from the narcissus signal by an apparent frequency shift that depends on the target's distance from the LIDAR system. This frequency shift makes it possible to separate the useful component from the narcissus signal, for example by digitally filtering the useful component of the detection signal, selectively with respect to the narcissus signal. This makes it possible for the LIDAR system of the invention to provide a velocimetric measurement result, and possibly also a telemetric measurement result, even for a target located a short distance in front of the output optic. Such a telemetric measurement can then proceed by determining the frequency shift that affects the retroreflected or backscattered part of the pulses at the moment of reception.

In such a LIDAR system, the modulation frequency that is varied within each pulse can be directly the optical frequency of that pulse's radiation. In other words, the LIDAR system can implement optical frequency modulation.

Alternatively, the modulation applied to the pulses emitted towards the target can be amplitude modulation, in particular sinusoidal amplitude modulation, with a sinusoid frequency that varies as a function of time within each pulse. This amplitude modulation sinusoid frequency is then the modulation frequency that is varied according to the invention.

The detection channel can be arranged to produce heterodyne detection of the retroreflected or backscattered portion of the pulses. In this case, the emission channel can be further adapted to apply to the emitted pulses an additional frequency shift which is constant, in addition to the modulation frequency variation within each pulse, and heterodyne detection is advantageously performed by mixing a reference signal which does not have this additional frequency shift, which is constant, with the retroreflected or backscattered portion of the pulses.

However, a LIDAR system conforming to the invention can alternatively implement a non-heterodyne detection mode. For example, the detection channel can be adapted to perform direct detection of the part of the pulses that has been retroreflected or backscattered by the target. In particular, such direct detection can be used when the modulation applied within each pulse is of the amplitude modulation type.

In particular, a LIDAR system in accordance with the invention can be adapted to measure airspeed. As mentioned above for this application, the target consists of particles that are located in a portion of atmosphere, the pulses are emitted by the emission channel towards the portion of atmosphere, and the detection channel is adapted to collect and detect the part of the pulses that has been backscattered by the particles located in the portion of atmosphere. In particular, again for this airspeed measurement application, the output optic can be adapted to transmit the pulses to the outside of the LIDAR system in the form of a converging beam of radiation, with convergence of this beam determining the portion of atmosphere concerned by the airspeed measurement. The measurement distance, that is, the distance away from the portion of atmosphere concerned by the airspeed measurement, can then be determined from the convergence applied to the beam of emitted pulses.

In preferred embodiments of the invention, the emission channel can be adapted to vary the modulation frequency within each pulse according to a constant-slope frequency modulation ramp. In addition, the emission channel can be further adapted to change a sign of the slope of this modulation frequency variation ramp between two pulses that are successively emitted. In particular, the slope of the modulation frequency variation ramp can be equal in absolute value but opposite in sign between two pulses that are emitted successively. In this case, the signal processing unit can be configured to obtain the result of the speed measurement from a sum of two respective frequency shifts relating to a first extracted useful component corresponding to those emitted pulses for which the slope of the modulation frequency variation ramp is positive, and to a second extracted useful component corresponding to those emitted pulses for which the slope of the modulation frequency variation ramp is negative. Simultaneously, the signal processing unit can be further configured to obtain an assessment of the target's distance from the LIDAR system from a difference between the respective frequency shifts relating to the first extracted useful component, which corresponds to those emitted pulses for which the slope of the modulation frequency variation ramp is positive, and the second extracted useful component, which corresponds to those emitted pulses for which the slope of the modulation frequency variation ramp is negative. Such an assessment of the distance to the target is then independent of a determination of this same distance obtained from the convergence of the pulse beam.

However, when the target's distance from the LIDAR system is otherwise known, the speed measurement can be obtained by varying the modulation frequency, which is the same for all pulses. This applies in particular to airspeed measurement when the distance to the portion of atmosphere concerned by the measurement is determined by the convergence of the radiation beam of emitted pulses.

In such an embodiment of the invention, for which the distance to the target is otherwise known, the emission channel can be adapted to emit the radiation pulses all with the same frequency modulation ramp. The signal processing unit can then be configured to obtain the result of the velocity measurement from a second contribution to a frequency offset that is relative to the extracted useful component, this second contribution being calculated by subtracting from the frequency offset a first contribution that is produced by the frequency modulation ramp in combination with the distance away from the target.

A second aspect of the invention proposes a method for measuring a velocity of at least one target using a LIDAR system, comprising the following steps:
/1/emitting radiation pulses towards the target through an output optic;
/2/using the output optic, collecting a portion of the pulses that have been retroreflected or backscattered by the target;
/3/detecting the retroreflected or backscattered portion of the pulses, using a photodetector which produces a detection signal; and
/4/from the detection signal, outputting a speed measurement result relative to the target.

According to the invention, the method has the following additional features:
a modulation frequency of the radiation is varied within each pulse during step/1/, so that a component of the detection signal used in step/4/for velocity measurement, referred to as the useful component, is spectrally shifted as a function of a distance of the target from the LIDAR system; and
the useful component is extracted from a spectrum of the detection signal in step /4/, so as to isolate this useful component from at least one other component of the detection signal which results from a retroreflection or partial backscattering of the emitted pulses occurring in the output optic, then the result of the velocity measurement is obtained from the extracted useful component.

Such a method can be used in particular, but not exclusively, for airspeed measurement. In addition, the LIDAR system can be placed on board an aircraft, and the method carried out while the aircraft is in flight.

Generally speaking, a method in accordance with the second aspect of the invention can be implemented using a LIDAR system that complies with the first aspect of the invention.

Different implementations of the method of the invention may employ at least one of the following additional features:
the modulation frequency that is varied within each pulse can be directly the optical frequency of the radiation of this pulse, or can be a sinusoid frequency of amplitude modulation of the radiation of each pulse;
the detection of the part of the pulses that has been retroreflected or backscattered can be heterodyne or direct detection;
the modulation frequency within each pulse can be varied according to a frequency modulation ramp with a constant slope. Possibly, a sign of the slope of this modulation frequency variation ramp can be changed between two pulses that are emitted successively. In particular, the slope of the modulation frequency variation ramp can be equal in absolute value but opposite in sign between two pulses that are emitted successively; and
for an anemometric application, the output optic can transmit the pulses to the outside of the LIDAR system in the form of a converging beam of radiation, with convergence of this beam determining the portion of atmosphere concerned by the airspeed measurement. In this case, all the radiation pulses can be emitted with the same frequency modulation ramp, and the result of the velocity measurement can be obtained from a second contribution to a frequency shift that is relative to the extracted useful component, this second contribution being calculated by subtracting from the frequency shift a first contribution that is produced by the frequency modulation ramp in combination with the distance away from the portion of atmosphere.

In particular, when two pulses that are emitted in succession have frequency modulation ramps with constant slopes and opposite signs, the result of the target velocity measurement can be obtained from a sum of two respective frequency shifts relating to a first extracted useful component that corresponds to those emitted pulses for which the slope of the radiation frequency modulation ramp is positive, and to a second extracted useful component that corresponds to those emitted pulses for which the slope of the radiation frequency modulation ramp is negative. In parallel, an evaluation of the target's distance from the LIDAR system can be obtained from a difference between the respective frequency shifts relative to these extracted first and second useful components.

### BRIEF DESCRIPTION OF THE FIGURES

The features and advantages of the present invention will become clearer in the following detailed description of non-limiting embodiments, with reference to the appended figures, among which:

FIG. 1 is a block diagram of a LIDAR system according to the invention, for an airspeed measurement application, with optical frequency modulation and heterodyne detection;

FIG. 2a and FIG. 2b are two spectrograms obtained with the LIDAR system of FIG. 1, for two measurement distance values;

FIG. 3 shows two spectra of a heterodyne detection signal obtained with the LIDAR system of FIG. 1;

FIG. 4 illustrates a possible application of the LIDAR system of FIG. 1; and

FIG. 5 corresponds to FIG. 1 for a target velocity measurement application with amplitude modulation and direct detection.

### DETAILED DESCRIPTION

For the sake of clarity, the dimensions of the elements shown in these figures do not correspond to actual dimensions or dimension ratios. In addition, some of these elements are shown only symbolically, and identical references shown in different figures designate elements that are identical or have identical functions.

The invention is first described for an airspeed measurement application, using optical frequency modulation. Secondly, it will be described for an application involving the measurement of the velocity of a solid object that constitutes the target, using amplitude modulation.

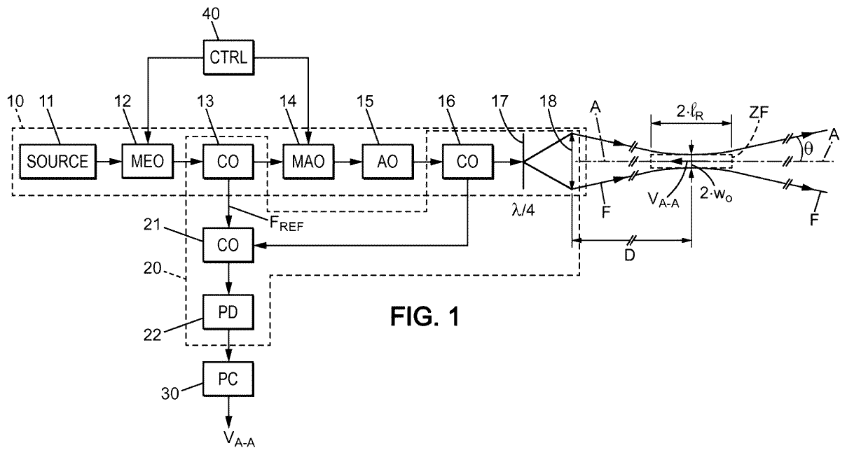

According to FIG. 1, a LIDAR system for airspeed measurement comprises a emission channel 10, a detection channel 20 and a signal processing unit 30.

The emission channel 10 comprises a laser source 11 denoted SOURCE, an optical modulator 14 denoted MAO, an optical amplifier 15 denoted AO, and an output optic 18. The laser source 11 may be of a continuous emission type, for example producing radiation of wavelength 2 equal to about 1.55 μm (micrometer). Modulator 14 can be of the acousto-optic type, and controlled to chop the radiation from laser source 11 into successive pulses. Typically, but not necessarily, the modulator 14 can also apply a constant frequency offset to the optical frequency of the radiation, for example an offset equal to around 40 MHz (megahertz). The optical amplifier 15 increases the power of the radiation pulses thus formed, and these pulses are transmitted outwards by the output optic 18 in the form of a beam F whose central direction of propagation is A-A. As is well known, chopping the radiation into successive pulses makes it possible to obtain high values of instantaneous radiation power within each pulse, which is particularly favorable for airspeed measurements. This type of pulsed emission operation can be used to achieve instantaneous radiation power values, within each pulse with a substantially rectangular profile, of between 100 W (watt) and 5 -10⁵ W, for example 500 W. Such values are not achievable for continuous laser radiation with the optical amplification components currently available or compatible with the anemometric application. The output optic 18 may consist of one or more converging lenses, and can determine the size of the output pupil of the emission channel 10. For example, this output pupil might have a radius of around 0.07 m (meter). The optical components of the emission channel 10, apart from the output optic 18, can advantageously be made using fiber optic technology, reducing the size of the LIDAR system and facilitating optical alignment of these components.

The output optic 18 is designed to produce the beam F of the radiation pulses with a convergent beam structure in a zone of space which is located downstream of this output optic, with respect to the direction of propagation of the radiation leaving the emission channel 10. The beam F thus has cross-sections, perpendicular to its central direction of propagation A-A, which decrease between the output optic 18 and a focusing zone ZF, then increase in the form of a divergent beam beyond this focusing zone ZF. In a known way, in particular using a Gaussian beam model, the focusing zone ZF can be likened to a cylinder with axis superimposed on the central direction of propagation A-A, radius w₀=λ/(πθ), commonly called “waist”, and length 2−I_{R}, WHERE I_{R} is the Rayleigh length equal to λ/(πθ²), θ being the half angle of divergence of the beam F beyond the focusing zone ZF, expressed in radian. Typically, the distance between the output optic 18 and the focusing zone ZF, which is denoted D and can be selected by adjusting a focal length or longitudinal position of the output optic 18, can vary between a few meters and several hundred meters, the Rayleigh length I_{R} then varying correlatively from a few tens of centimeters to a few meters, and the radius w₀ being of the order of a few centimeters. Generally speaking, the half-angle of divergence θ of the F beam can be evaluated downstream of the focusing zone ZF in the direction of radiation propagation, at a distance from the focusing zone ZF that can be equal to 1 km (kilometer).

To perform heterodyne detection, the detection channel 20 may comprise a photodetector 22, denoted PD, and optical couplers 13, 16 and 21, denoted CO, which are arranged to combine a backscattered portion of the beam F with a portion F_{REF} of the radiation from the laser source 11. This part of the radiation F_{REF} acts as the reference radiation for heterodyne detection. In a known way, the backscattered part of the beam F that is thus detected comes essentially from the focusing zone ZF, and is produced by backscattering particles that are located in this zone. The optical coupler 16 can advantageously be of the polarization-separation type, in which case the radiation coming from the optical amplifier 15 is linearly polarized, and a quarter-wave plate 17, denoted λ/4, is inserted between the optical coupler 16 and the output optic 18. The optical coupler 16 and the quarter-wave plate 17 thus form an optical circulator that couples the emission channel 10 and the detection channel 20 to the shared output optic 18.

Finally, the signal processing unit 30 can be a PC-based computer module which hosts an appropriate program for processing the detection signal delivered by the photodetector 22. The signal processing unit 30 outputs an evaluation of the velocity component of the backscattering particles in the focusing zone ZF, this component being parallel to the central direction of propagation A-A and denoted V_{A-A}.

The operation of such a LIDAR system for airspeed measurements is well known to those skilled in the art, so there is no need to repeat it here. The system is oriented and the half-angle of divergence 0 adjusted so that the focusing zone ZF is in a portion of the atmosphere where the wind speed is to be measured. The particles backscattering the beam F are dust, microcrystals or aerosol droplets suspended in the atmosphere inside the focusing zone ZF. The structure of the output optic 18, and its control when it allows variable adjustment of the divergence half-angle 0, can provide an assessment of the distance of a center of the focusing zone ZF from the LIDAR system, corresponding then to the distance D that was previously introduced.

For the invention, the emission channel 10 further comprises additional modulation means, which are adapted to vary the optical frequency of the radiation within each of the pulses as formed by the acousto-optic modulator 14. For example, these additional frequency modulation means can consist of an electro-optical modulator 12, denoted MEO, with a suitable control unit thereof, designated by reference 40, denoted CTRL and called modulation controller. They can be inserted between the laser source 11 and the acousto-optic modulator 14. In various embodiments of the invention, these frequency modulation means can be arranged upstream or downstream of the optical coupler 13, which samples the reference radiation F_{REF}. It will be assumed in the following that they are arranged upstream of the optical coupler 13 with respect to the direction of propagation of the radiation in the emission channel 10, and the person skilled in the art will know how to adapt the following description to the case of an arrangement of the additional modulation means downstream of the optical coupler 13.

For example, the modulation controller 40 is configured so that the acousto-optic modulator 14 chops the radiation initially produced by the laser source 11 into successive pulses of individual durations equal to 1 μs (microsecond), and so that the electro-optic modulator 12 applies a linear increase in the optical frequency of the radiation within each pulse, from around 0 MHz (megahertz) at the start of the pulse to around 500 MHz at the end of the pulse. The slope p of the optical frequency variation is then equal to +0.500 MHz/ns (megahertz per nanosecond). The part of the pulses produced by the emission channel 10 that is backscattered in the focusing zone ZF then reaches the photodetector 22 with a propagation delay relative to the reference radiation F_{REF}, this delay corresponding to the round-trip propagation time between the emission optics 18 and the focusing zone ZF. As a result of the frequency modulation introduced according to the invention, it then has a first frequency shift contribution with respect to the reference radiation F_{REF}, which is equal to −p−2−D/C, where C is the propagation velocity of the radiation outside the LIDAR system between the output optic 18 and the focusing zone ZF. This first frequency shift contribution is referred to as Δf₁ in the following. In a known way, the V_{A-A} component of the velocity of the backscattering particles contained in the focusing zone ZF, this component being parallel to the central direction of propagation A-A, produces a second frequency shift contribution, denoted Δf₂ and equal to 2−V_{A-A}/λ, when the airspeed V_{A-A} is oriented as shown in FIG. 1. For the embodiment of the invention in FIG. 1, the two contributions Δf₁ and Δf₂ are added to create the frequency of the heterodyne detection signal that is output by photodetector 22. They are also added to the constant frequency shift that may be produced by the acousto-optic modulator 14.

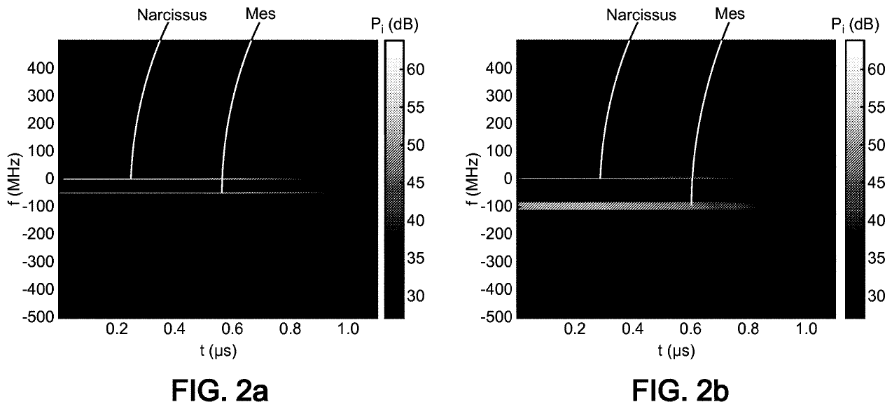

FIG. 2a and FIG. 2b show the frequencies of the spectral components of the heterodyne detection signal, as a function of time within each pulse. For each spectrogram, the horizontal axis marks the time, denoted t and expressed in microseconds (μs), the vertical axis marks the frequency, denoted f and expressed in megahertz (MHz), and the tone scale to the right of each spectrogram marks the instantaneous spectral power, denoted Pi and expressed in decibels (dB) relative to a noise-related base level. For the spectrogram in FIG. 2a, the output optic 18 is adjusted so that the distance D from the focusing zone ZF is equal to 15 m (meter). The 2−I_{R} length of this focusing zone ZF is then equal to 90 cm (centimeter). For the spectrogram in FIG. 2b: D is equal to 30 m and 2−I_{R} is equal to 3.5 m. The numerical values of the other LIDAR system parameters are those already cited, identical for both spectrograms, except for the value of the constant frequency shift produced by the acousto-optic modulator 14, which is zero. The two components of the heterodyne detection signal that appear in each spectrogram correspond respectively to a partial retroreflection of the pulses on the output optic 18, designated “Narcisse” in the spectrograms and called the narcissus signal, and to the part of the pulses that has been backscattered in the focusing zone ZF, designated “Mes” and called the measurement signal. The narcissus signal corresponds to D=0 and f=0, since it has no significant propagation delay on arrival at photodetector 22 compared with the reference radiation F_{REF}, nor any Doppler effect. The measurement signal reaches the photodetector 22 with a delay At equal to 2−D/C compared to the narcissus signal, and has a frequency f that is offset from the first contribution Δf₁ in the absence of wind in the focusing zone ZF. For the operating conditions adopted, the delay Δt is equal to 0.10 μs for FIGS. 2a and 0.20 μs for FIG. 2b, and Δf₁ is equal to 50 MHz for FIGS. 2a and 100 MHz for FIG. 2b. The initial instant (t=0) in these two spectrograms corresponds to the start of detection of the backscattered part of the radiation pulse. In addition, the spectral width of the measurement signal is greater in FIG. 2b than in FIG. 2a, due to the much longer focusing zone ZF in FIG. 2b.

The signal processing unit 30 calculates a Fourier transformation with respect to time of the heterodyne detection signal output by the photodetector 22. It then extracts the measurement signal from the spectrum of the heterodyne detection signal, for example by applying adaptive digital filtering, and determines the frequency f of this measurement signal. Generally speaking, this frequency f is equal to Δf₀+Δf₁+Δf₂, where Δf₀ is the constant frequency offset within all pulses that is produced by the acousto-optic modulator 14, if any. When the distance D is otherwise known, in particular by adjusting the focus of the output optic 18, the frequency shift contribution Δf₁ is calculated by Δf₁ =−p−2−D/C, and the two contributions Δf₀ and Δf₁ are subtracted from the value determined for the frequency f of the measurement signal. The result of this subtraction is the frequency shift contribution Δf₂, which corresponds to the Doppler effect, and the wind speed component in the focusing zone ZF, parallel to the central propagation direction A-A, is calculated by the signal processing unit 30 according to the formula: V_{A-A}=λΔf₂/2.

The measurement signal “Mes” as just described as the spectral component that is extracted from the heterodyne detection signal, has been referred to as the useful component of the detection signal in the general part of this description.

However, for airspeed measurements, the distance D away from the ZF focusing zone may depend on factors external to the LIDAR system, such as atmospheric turbulence and/or thermal variations in the air present in the pulse path between the output optic 18 and the focusing zone ZF, and/or variations in the concentration of backscattering particles along the central propagation direction A-A. The improvement now described makes it possible to deduce the actual value of the distance D from the heterodyne detection signal. To achieve this, the modulation controller 40 can be configured so that some of the pulses are emitted with a specific, e.g., positive, linear optical frequency variation ramp slope, and other pulses with a negative linear optical frequency variation ramp slope. Preferably, every other pulse is emitted with a linear ramp slope p that is positive, and the other pulses are emitted using −p as the linear ramp slope. Then, for the first pulses, the frequency of the measurement signal as resulting from heterodyne detection is Δf₀+Δf₁+Δf₂, as before, and is denoted f₊. For pulses with a linear ramp slope −p, the frequency of the measurement signal resulting from heterodyne detection is Δf₀−Δf₁+Δf₂, denoted f₋. The two frequencies f₊ and f₋ are determined by the signal processing unit 30 in the same way as above. Unit 30 then determines the contributions Δf₁ and Δf₂ as follows: Δf₁=(f₊−f₋)/2, and Δf₂=(f₊+f₋)/2−Δf₀. It then calculates the airspeed VA-A as before from the value of the contribution Δf₂ and provides an assessment of the distance D by applying the following formula: D=−C Δf₁/(2−p).

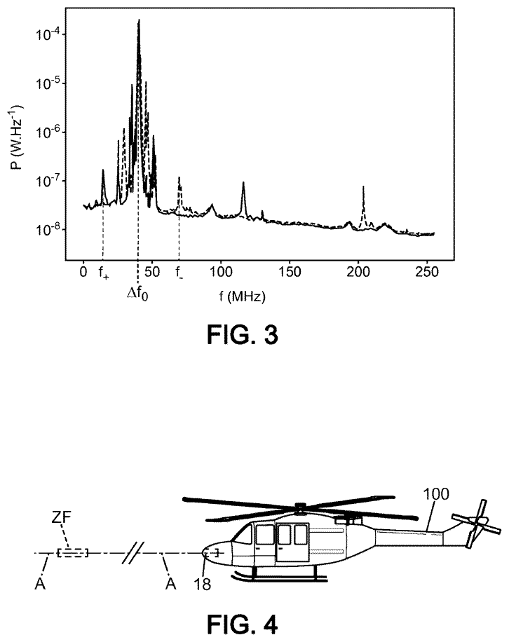

FIG. 3 shows the heterodyne detection signal that is obtained for such an implementation of the invention, with slopes of linear optical frequency variation ramps that are opposite between two successive pulses. This diagram separates the spectrum of pulses with a positive slope value, shown as a solid line, from that of pulses with a negative slope value, shown as dashed lines. The horizontal axis again indicates the frequency values f expressed in megahertz, and the vertical axis indicates the spectral intensity values expressed in watts per hertz (W-Hz⁻¹) and denoted P. This composite heterodyne detection spectrum has been established for a value equal to 40 MHz of the constant frequency offset Δf₀ which is produced by the acousto-optic modulator 14. The two spectra each show several narcissus signal components, corresponding to partial reflections of the pulses on several components of the output optic 18, as well as on the quarter-wave plate 17. These narcissus signal components are less than 15 MHz from the 40 MHz value for f, corresponding to Δf₀. The measurement signals corresponding to the two opposite slopes are designated by their respective frequency values f₊ and f₋. The other signals, corresponding to peaks in the spectra with frequency f values above 90 MHz, come from reflections of oppositely-sloping pulses on obstacles in the background of the focusing zone ZF. Peaks at 115 MHz and 205 MHz reveal an obstacle with high backscattering power, located at distance D′ =−C−Δf₁/(2−p) with Δf₁=(205 MHz-115 MHz)/2=45 MHz, that is, D′=13.5 m. For these same spectra, according to the values of 15 MHz and 65 MHz read for f₊ and f₋, respectively, the distance D from the focusing zone ZF is equal to approximately 7.5 m, and the wind speed in this focusing zone ZF is less than 1 m. s⁻¹ (meter per second).

The above examples demonstrate the value of the frequency modulation introduced by the invention, for spectrally separating the measurement signal from the narcissus signal, or from all the components of the narcissus signal, as the case may be. Thanks to frequency modulation, the part of the emitted pulses that is backscattered by airborne particles can be distinguished from the narcissus signal, even at very low wind speeds. This distinction can still be made for small values of distance D.

A LIDAR system which conforms to the invention and which is suitable for carrying out airspeed measurements can be used in many applications, including but not limited to:
on-board aircraft applications, where the reduced size and weight of the LIDAR system are major advantages. FIG. 4 shows a helicopter 100 equipped with such a LIDAR system to carry out airspeed measurements in accordance with the invention. The system is preferably installed on-board the helicopter so that the output optic 18 is located towards the nose of the helicopter 100, and turned towards the half-space in front of the helicopter. FIG. 4 shows the arrangement of the central direction of propagation A-A and the resulting focusing zone ZF;
applications where the airspeed to be measured may be low or very low, such as measurements at ground level or low altitude, for example to optimize wind turbine operation, or measurements from aircraft that may be hovering. In this case, the acousto-optic modulator 14 advantageously generates the constant frequency shift Δf₀ which is applied to the emitted pulses without being applied to the reference radiation F_{REF}. In this way, an airspeed value that is low corresponds to a heterodyne beat frequency that is close to the non-zero value of Δf₀, so that measurement accuracy is improved without the need to implement a large number of pulses per measurement sequence, that is, without the measurement time being too long; and
applications where the measuring distance between the output optic 18 and the focusing zone ZF is variable. To this end, the output optic 18 can be adapted so that the convergence of the beam F of successive pulses is variable as it exits through this optic. For example, when this beam originates from an optical fiber end, the output optic 18 may be a converging lens mounted on a support that is translatable parallel to the A-A direction, so as to move the object focus of the lens relative to the optical fiber end. In this way, the center O of the focusing zone ZF can be located at a controllable distance from the output optic 18, for example between 1 m and 1000 m.

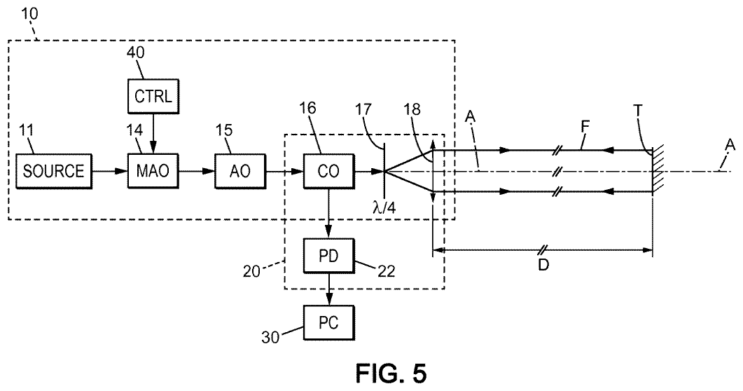

The embodiment of the invention shown in FIG. 5 is suitable for measuring the speed of a retroreflective target T. If the target T has sufficient retroreflectivity, it is no longer necessary for the beam F of the emitted pulses to be convergent. This beam can then be collimated, making it possible to measure the speeds of targets located at distances D that vary over a very wide range.

The embodiment in FIG. 5 uses direct detection of the part of the pulses that is retroreflected by the target T, instead of the heterodyne detection of FIG. 1. For this purpose, the optical frequency modulation used previously can be replaced by amplitude modulation, which is carried out with a variable modulation frequency. Such amplitude modulation with varying modulation frequency can be produced by the acousto-optic modulator 14, when the modulation controller 40 is suitably configured. For example, the acousto-optic modulator 14 produces a sinusoidal amplitude modulation within each pulse, and the frequency of this sinusoidal amplitude modulation varies between the beginning and end of the pulse. Preferably, it varies linearly with time, that is, with a rate of change. By way of example, the modulation frequency of the radiation amplitude in each pulse can vary between the initial value of 10 MHz at the start of the pulse, and the final value of 100 MHz at the end of the pulse.

The resulting variations in instantaneous power for the part of the pulses that has been retroreflected by the target T are sufficiently slow to be detected in real time by the photodetector 22. The detection signal delivered by the latter can then be analyzed by the signal processing unit 30 in the same way as before. For this reason, the description of this analysis is not repeated. It is only indicated that the refinement of successively emitted pulses that have opposite slopes of linear variation of the modulation frequency is still applicable, by applying it to the variable amplitude modulation frequency.

It is understood that the invention can be reproduced by modifying secondary aspects of the embodiments that have been described in detail above, while retaining at least some of the cited advantages. In particular, the components mentioned can be replaced by other components or combinations of components which produce a function equivalent to that mentioned. Finally, the numerical values quoted are for illustrative purposes only and may be changed depending on the application in question.

1-13. (canceled)

14. A LIDAR system adapted to measure a velocity of at least one target, and comprising:
a emission channel, adapted to emit radiation pulses towards the target through an output optic of the LIDAR system;
a detection channel, comprising a photodetector, and adapted to collect, also through the output optic, and direct onto the photodetector, a portion of the pulses that has been retroreflected or backscattered by the target, so as to produce a detection signal; and
a signal processing unit, configured to output a target-related speed measurement result from the detection signal,
the LIDAR system being characterized in that:
the emission channel is further adapted to vary a modulation frequency of the radiation within each pulse, so that a component of the detection signal that is useful for measuring velocity, referred to as the useful component, is spectrally shifted as a function of a distance of the target from the LIDAR system; and
the signal processing unit is further configured to extract the useful component from a spectrum of the detection signal, so as to isolate said useful component from at least one other component of the detection signal which results from partial retroreflection or backscattering of the emitted pulses occurring in the output optic (18) of the LIDAR system, and to obtain the result of the velocity measurement from the extracted useful component.

15. The LIDAR system according to claim 14, adapted to measure airspeed, the target being particles which are located in a portion of atmosphere, the pulses being emitted by the emission channel towards the portion of atmosphere, and the detection channel being adapted to collect and detect that part of the pulses which has been backscattered by the particles located in said portion of atmosphere.

16. The LIDAR system according to claim 14, adapted so that the modulation frequency which is varied within each pulse is an optical frequency of the radiation of said pulse.

17. The LIDAR system according to claim 14, wherein the emission channel is adapted to vary the modulation frequency within each pulse according to a constant-slope frequency modulation ramp.

18. The LIDAR system according to claim 17, wherein the emission channel is adapted to emit the radiation pulses all with the same frequency modulation ramp, and wherein the signal processing unit is configured to obtain the result of the velocity measurement from a second contribution to a frequency offset that is relative to the extracted useful component, said second contribution being calculated by subtracting from said frequency offset a first contribution which is produced by the frequency modulation ramp in combination with the distance away from the target.

19. The LIDAR system according to claim 17, wherein the emission channel is adapted to change a sign of the slope of the modulation frequency variation ramp between two pulses that are emitted successively.

20. The LIDAR system according to claim 19, wherein the emission channel is adapted so that the slope of the modulation frequency variation ramp is equal in absolute value but opposite in sign between two pulses which are emitted successively.

21. The LIDAR system according to claim 20, wherein the signal processing unit is configured to obtain the result of the velocity measurement from a sum of two respective frequency shifts relating to a first extracted useful component which corresponds to those emitted pulses for which the slope of the modulation frequency variation ramp is positive, and to a second extracted useful component which corresponds to those emitted pulses for which the slope of the modulation frequency variation ramp is negative.

22. The LIDAR system according to claim 21, wherein the signal processing unit is further configured to obtain an evaluation of the distance of the target from the LIDAR system from a difference between the respective frequency shifts relating to the first extracted useful component which corresponds to those emitted pulses for which the slope of the modulation frequency variation ramp is positive, and the second extracted useful component which corresponds to those emitted pulses for which the slope of the modulation frequency variation ramp is negative.

23. The LIDAR system according to claim 14, wherein the detection channel is arranged to perform heterodyne detection of the retroreflected or backscattered portion of the pulses.

24. A method of measuring a velocity of at least one target using a LIDAR system, comprising the following steps:
/1/emitting radiation pulses in the direction of the target through an output optic (18);
/2/using the output optic, collecting a portion of the pulses that have been retroreflected or backscattered by the target;
/3/detecting the retroreflected or backscattered portion of the pulses, using a photodetector which produces a detection signal; and
/4/from the detection signal, outputting a speed measurement result relative to the target,
the method being characterized in that:
a modulation frequency of the radiation is varied within each pulse during step/1/, so that a component of the detection signal used in step/4/for velocity measurement, referred to as the useful component, is spectrally shifted as a function of a distance of the target from the LIDAR system; and
the useful component is extracted from a spectrum of the detection signal in step/4/, so as to isolate said useful component from at least one other component of the detection signal which results from a partial retroreflection or backscattering of the emitted pulses occurring in the output optic, then the result of the velocity measurement is obtained from the extracted useful component.

25. The method according to claim 24, used to measure airspeed, according to which the target consists of particles which are located in a portion of atmosphere, the pulses are emitted in the direction of the portion of atmosphere, and the part of the pulses which has been backscattered by the particles located in said portion of atmosphere is collected and detected.

26. The method according to claim 24, wherein the LIDAR system is carried on board an aircraft, and the method is carried out during a flight of the aircraft.
